(19) United States
(12) Patent Application Publication
(10) Pub. No.: US 2014/0022640 A1
(43) Pub. Date: Jan. 23, 2014

(54) ILLUMINATION SYSTEM FOR ANECHOIC CHAMBER

(71) Applicants: YONG-SHENG YANG, Shenzhen City (CN); XIAO-LIAN HE, Shenzhen City (CN)

(72) Inventors: YONG-SHENG YANG, Shenzhen City (CN); XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/568,110

(22) Filed: Aug. 6, 2012

(30) Foreign Application Priority Data
Jul. 23, 2012 (CN) 2012102545507

(51) Int. Cl. F21S 11/00

(52) U.S. Cl. 359/509; 359/591; 359/597

(57) ABSTRACT

An illumination system for illumining an anechoic chamber includes a light gathering device mounted on an outer surface of the anechoic chamber for gathering daylight, a light guiding post mounted to the anechoic chamber, and a diffusion device received in the anechoic chamber. The light guiding post is connected between the light gathering device and the diffusion device. The light guiding post includes two shields mounted in the light guiding post, which are respectively adjacent to the light gathering device and the diffusion device, to protect the anechoic chamber from electrostatic or magnetic interference.

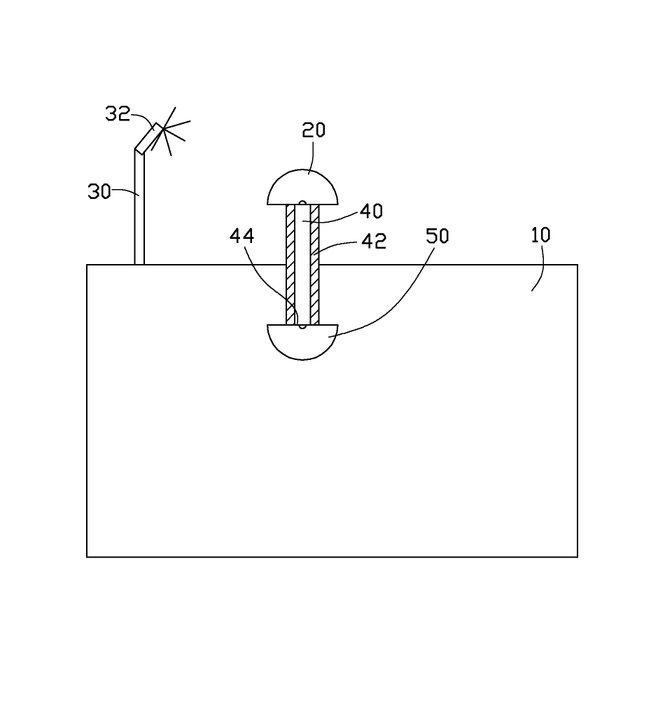

### BACKGROUND

1. Technical Field

The present disclosure relates to an illumination system.

2. Description of Related Art

Anechoic chambers are often used to test many kinds of electronic devices. Halogen lights are generally mounted to ceilings of the chambers for illumination. However, halogen lights consume a lot of energy, and generate a lot of heat which makes the lights' service life short. As a result, halogen lights need to be replaced after a short time of use, which is inconvenient and costly.

### BRIEF DESCRIPTION OF THE DRAWING

Many aspects of the present embodiments can be better understood with reference to the following drawing. The components in the drawing are not necessarily drawn to scale, the emphasis instead being placed upon clearly illustrating the principles of the present embodiments. Moreover, in the drawing, the view is schematic, and like reference numerals designate corresponding parts throughout the single view.

The FIGURE is a schematic, plan view of an exemplary embodiment of an illumination system for a darkroom.

### DETAILED DESCRIPTION

The disclosure, including the accompanying drawing, is illustrated by way of example and not by way of limitation. It should be noted that references to “an” or “one” embodiment in this disclosure are not necessarily to the same embodiment, and such references mean at least one.

The FIGURE shows an exemplary embodiment of an illumination system for illuminating an anechoic chamber 10. The illumination system includes a light gathering device 20 mounted on a top surface of the anechoic chamber 10 for gathering daylight, a cleaning member 30 mounted on the top surface of the anechoic chamber 10, a diffusion device 50 received in the anechoic chamber to diffuse daylight, and a light guiding post 40 extending through the top of the anechoic chamber 10.

The light guiding post 40 is connected between the light gathering device 20 and the diffusion device 50, to transmit daylight gathered by the light gathering device 20 to the diffusion device 50. A reflecting portion 42 is mounted to an inner surface of the light guiding post 40 to reflect the daylight. Two shields 44 are mounted in the light guiding post 40, and are respectively adjacent to the light gathering device 20 and the diffusion device 50, to protect the anechoic chamber 10 from electrostatic or magnetic interference from outside the anechoic chamber 10. The reflecting portion 42 can be reflecting paint or a reflector.

The cleaning member 30 includes a nozzle 32 mounted at a top end. The cleaning member 30 can spray water on the light gathering device 20 through the nozzle 32 to clean a surface of the light gathering device 20.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. An illumination system for illuminating an anechoic chamber, the system comprising:
a light gathering device mounted on an outer surface of the anechoic chamber for gathering daylight;
a diffusion device received in the anechoic chamber to diffuse daylight gathered by the light gathering device; and
a light guiding post extending into the anechoic chamber, and connected between the light gathering device and the diffusion device to guide the daylight gathered by the light gathering device to the diffusion device, the light guiding post comprising two shields mounted in the light guiding post and respectively adjacent to the lighting device and the diffusion device, two shields protecting the anechoic chamber from electrostatic or magnetic interference from outside the anechoic chamber.

2. The system of claim 1, further comprising a cleaning member comprising a nozzle, wherein the cleaning member sprays water on the light gathering device through the nozzle.

3. The system of claim 1, wherein the light guiding post comprises a reflecting portion mounted to an inner surface of the light guiding post.

4. The system of claim 3, wherein the reflecting portion is reflecting paint.

5. The system of claim 5, wherein the reflecting portion is a reflector.
